(19) United States
(12) Patent Application Publication
(10) Pub. No.: US 2018/0297817 A1
(43) Pub. Date: Oct. 18, 2018

(54) ELEVATOR CAR PANEL

(71) Applicant: Otis Elevator Company, Farmington, CT (US)

(72) Inventors: Juan Jose Fernandez, Leganes (Madrid) (ES); Jose Luis Hortelano, Leganes (Madrid) (ES); Carlos Leirad, Leganes (Madrid) (ES)

(21) Appl. No.: 15/767,743

(22) PCT Filed: Oct. 15, 2015
(86) PCT No.: PCT/EP2015/073889

§ 371 Date: Apr. 12, 2018

(51) Int. Cl. B66B 11/02

(52) U.S. Cl. CPC B66B 11/0253

(57) ABSTRACT

An elevator car panel (16, 16a), which is configured to be attached to at least one structural element (14) of an elevator car (2) comprises at least one opening (18) formed in a surface of the elevator car panel (16, 16a) for receiving at least one magnet (28); and at least one magnet (28) arranged within said one opening (18), wherein the at least one magnet (28) is configured for magnetically fixing the elevator car panel (16, 16a) to the at least one structural element (14).

The invention is related to an elevator car panel, in particular an elevator car panel which is configured to be attached to at least one structural element of an elevator car.

The cars of elevators intended for passenger transportation usually are provided with a two layer structure including an outer layer formed by a plurality of structural elements providing the necessary rigidity and strength of the elevator car, and an inner layer formed by a plurality of decorative elevator car panels for separating the passengers from the structural elements and providing a comfortable interior of the elevator car.

For facilitating and accelerating the assembly of the elevator car, it would be beneficial to provide elevator car panels which may be attached to the structural elements fast and easily.

According to an exemplary embodiment of the invention, an elevator car panel, which is configured to be attached to at least one structural element of an elevator car, in particular to a structural element including a magnetic material, comprises at least one opening, which is formed in a surface of the elevator car panel for receiving at least one magnet; and at least one magnet, which is arranged within said one opening. The at least one magnet is configured for fixing the elevator car panel to the at least one structural element by means of its magnetic forces.

Exemplary embodiments of the invention also include an elevator car comprising at least one structural element comprising a magnetic material, and at least one elevator car panel according to an exemplary embodiment of the invention.

Exemplary embodiments of the invention further include a method of assembling an elevator car comprising the steps of providing at least one structural element comprising a magnetic material and attaching at least one elevator car panel according to an exemplary embodiment of the invention to said at least one structural element by means of the magnetic force provided by the at least one magnet.

Using the magnetic force provided by the at least one magnet, the elevator car panel may be fixed to at least one magnetic structural element fast and easily. No additional fastening elements or tools need to be used for fixing the elevator car panel.

As a result, the elevator car may be assembled fast and with low costs. No fixing elements are visible from the interior of the elevator car. This provides an improved aesthetics and prevents passengers from manipulating the fixing elements or even detaching the elevator car panels. An authorized service technician may use a suction bell for removing the elevator car panels, when necessary.

Exemplary embodiments of the invention will be described in the following with respect to the enclosed figures.

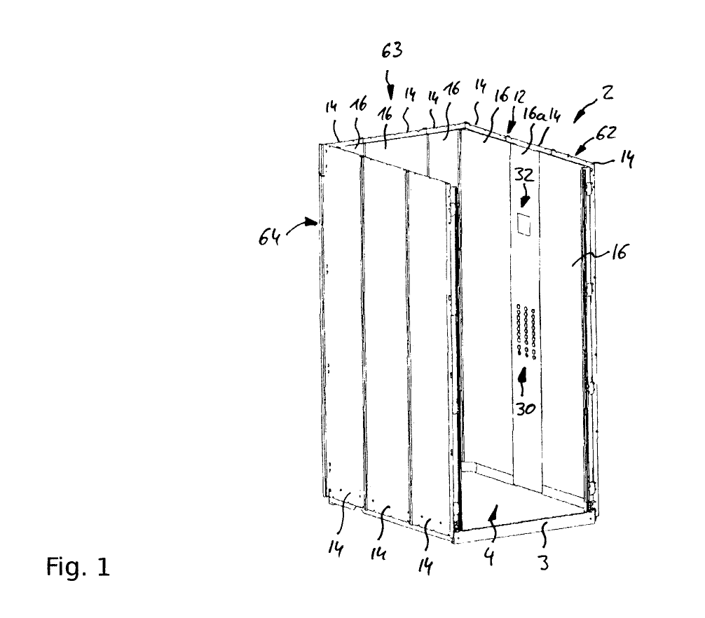

FIG. 1 shows a perspective view of an elevator car comprising a plurality of structural elements as well as a plurality of elevator car panels.

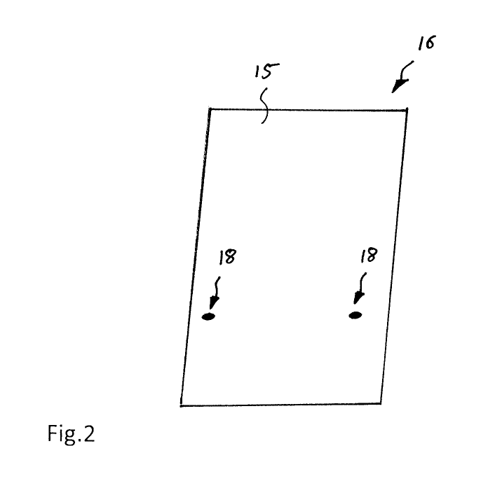

FIG. 2 shows a rear view of an elevator car panel according to an embodiment of the invention.

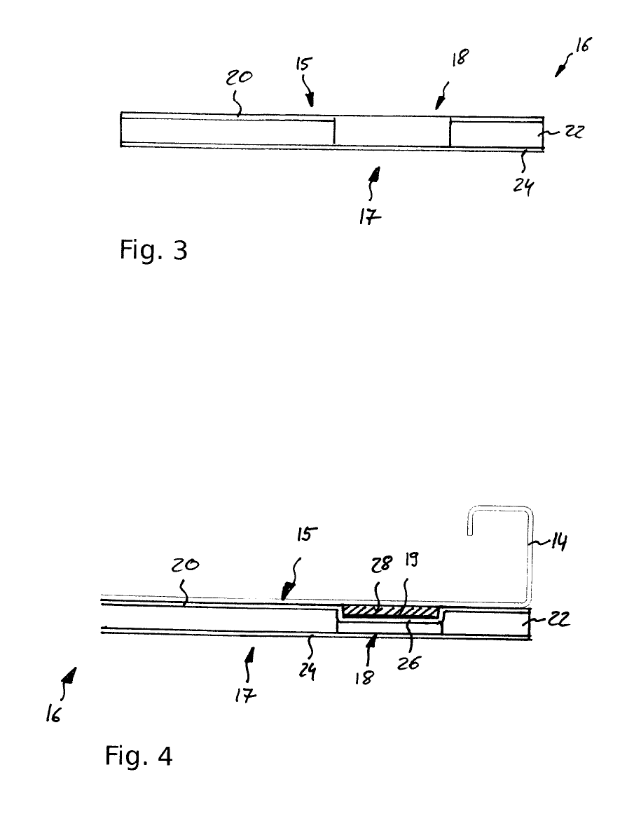

FIG. 3 shows a sectional view of an elevator car panel according to an embodiment of the invention.

FIG. 4 shows a sectional view of an elevator car panel according to an embodiment of the invention, which is attached to a structural element.

FIG. 1 shows a perspective view of an elevator car 2 comprising a plurality of elevator car panels 16, 16a according to an exemplary embodiment of the invention.

The elevator car 2 comprises a basically horizontally oriented bottom plate 3 and three sidewalls 62, 63, 64. The sidewalls 62, 63, 64 are constituted by a plurality of structural elements 14 extending vertically upwards from the bottom plate 3 and define a prismatic interior space 4 providing a passenger compartment of the elevator car. The structural elements 14 are made of a structurally rigid material and comprise a magnetic material, i.e. a material producing an attractive force under the influence of a magnetic field, as produced by a magnet. A magnet is attracted by such magnetic material. The attractive force is particularly large in case the magnet directly contacts the magnetic material without any airgap in between. Typically, a magnetic material includes a ferromagnetic material. Typically, the structural elements 14 will be made of a metallic material and may comprise a magnetic metallic material, e.g. steel.

The top plate/ceiling and the front sidewall of the elevator car 2 including the car door are not shown in FIG. 1 in order to allow an unobstructed view into the elevator car's interior space 4.

A plurality of elevator car panels 16, 16a are arranged on an inner side of the structural elements 14 facing the interior space 4.

One of the elevator car panels 16, 16a is provided as an elevator control panel 16a comprising a plurality of push buttons 30, which are configured for controlling operation of the elevator system, and a display 32 allowing to provide information related to the status of the elevator system, e.g. the number of the floor in which the elevator car 2 is actually located, to passengers situated within the elevator car 2.

The elevator car panels 16, 16a are attached to the structural elements 14 by means of magnets. A magnet is a material or object that produces a magnetic field. This magnetic field is responsible for producing an attractive force with respect to ferromagnetic materials, such as iron or steel. This will be described in more detail further below.

In the embodiment shown in FIG. 1, each of the sidewalls 62, 63, 64 is respectively formed by three structural elements 14, which are arranged adjacent to each other. An elevator car panel 16, 16a is attached to each of the structural elements 14.

The configuration depicted in FIG. 1, however, is only exemplar. The skilled person easily understands that an arbitrary number of structural elements 14 may be used for forming each of the sidewalls 62, 63, 64, and that the number of elevator car panels 16, 16a attached of each sidewall 62, 63, 64 may differ from the number of structural elements 14 which are used for forming said sidewall 62, 63, 64. Of course, the number of sidewalls 62, 63, 64 may be different, as well.

FIG. 2 shows a rear view of an elevator car panel 16 according to an exemplary embodiment of the invention. FIG. 2 in particular shows the rear side 15 of the elevator car panel 16, i.e. the side facing the structural element(s) 14 when the elevator car panel 16 is installed within the elevator car.

Two openings 18 are formed within the rear side of the elevator car panel 16. Each of the openings 18 is configured for housing a magnet (not shown). The magnets are fixed within their respective opening 18. This allows for fixing the elevator car panel 16 to at least one of the structural elements 14 by means of the magnetic force provided by each of the magnets.

In the embodiment shown in FIG. 2, the openings 18 are formed with a circular cross-section. This kind of openings 18 may be formed easily, e.g. by means of drilling. However, alternative shapes of the openings 18, e.g. elliptical, rectangular, hexagonal, octagonal, or other shapes of the openings 18, are possible, as well. Also, the number of openings 18 may be different from two. In particular, more than two openings 18 may be provided. The openings 18 may be distributed over the rear side 15 of the elevator car panel 16 as desired.

FIG. 3 shows a sectional view of an elevator car panel 16 according to an exemplary embodiment of the invention.

The elevator car panel 16 shown in FIG. 3 is provided as a laminate panel with three different layers 20, 22, 24, namely a central layer 22 sandwiched between two outer layers 20, 24. One of the outer layers forms a front layer 24. The other of the outer layers forms a rear layer 20.

The central layer 22 in particular may be a central foam layer, and the two outer layers 20, 24 may be made of paper or cardboard attached to the central layer 22.

The front layer 24, which is arranged on the visible front side 17 of the elevator car panel 16 facing the interior space 4 of the elevator car 2, in particular may be made of decorative paper with a desired design. The rear layer 20 on the rear side 15 facing the structural element(s) 14 may be made of the same, similar or different paper or cardboard, which in particular may have a plain, non-decorative color.

An elevator car panel 16 with such a configuration having three layers 20, 22, 24 provides a lightweight elevator car panel 16, which nevertheless comprises the necessary rigidity and which may be produced at low costs.

The elevator car panel 16 further comprises at least one opening 18 for receiving a magnet (not shown). The opening 18 is open to the rear side 15 facing the structural element(s) 14 when the elevator car panel 16 is installed within the elevator car 2.

FIG. 4 shows a sectional view of an elevator car panel 16 according to an exemplary embodiment of the invention, the rear side 15 of the elevator car panel 16 being attached to an adjacent structural element 14 of the elevator car 2.

The elevator car panel 16 comprises the same laminate structure with three layers 20, 22, 24, as it has been described with reference to FIG. 3.

A cup 26, which is configured for receiving a magnet 28, is fixedly arranged within the opening 18 formed in the elevator car panel 16. The opening of the cup 26 faces the rear side 15 of the elevator car panel 16, which abuts against the structural element 14 of the elevator car 2.

A magnet 28 is fixed within the cup 26, e.g. by means of an appropriate adhesive material 19.

The cup 26 in particular is made of or at least comprises a ferromagnetic material configured to direct the magnetic field provided by the magnet 28 to the rear side 15 of the elevator car panel 16 and configured to shield the magnetic field from the front side 17 facing the interior 4 of the elevator car 2. For example, the cup 26 may include, or may be made of, a soft magnetic material, i.e. a ferromagnetic material which can be magnetized but does not tend to stay magnetized in the absence of a magnetic field. Soft magnetic materials have a low coercive force. This shielding and directing enhances the magnetic force exerted by the magnet 28 to the structural element 14 and thereby amplifies the fixing of the elevator car panel 16 to the adjacent structural element(s) 14. It further avoids that passengers residing within the elevator car 2 are exposed to the magnetic field provided by the magnet 28.

According to alternative embodiments, the magnet 28 may be fixed, e.g. glued, directly to the back side of the front layer 24 or may be fitted into a recess formed with the central layer 22. In such embodiments, no cup 26 is provided within the opening 18.

The magnet 28 may be provided as a permanent magnet 28, i.e. may comprise a magnetically “hard” material which tends to stay magnetized in the absence of a magnetic field. Typical “hard” ferromagnetic materials include Al—Ni—Co alloy and ferrite. These materials are subjected to special processing in a strong magnetic field during manufacture to align their internal microcrystalline structure. “Hard” ferromagnetic materials have high coercive force. Very “hard” ferromagnetic materials comprise rare earth materials, e.g. neodymium or similar material, for providing a strong magnetic field, in particular a magnetic filed having sufficient strength for reliably fixing the elevator car panel 16 to an adjacent structural element 14 of the elevator car 2. Using a permanent magnet 28 allows to fix the elevator car panel 16 to any structural element 14 made of magnetic material, e.g. to a structural element 14 made of steel.

In the embodiment shown in FIG. 4, the outer surface of the magnet 28 facing the structural element 14 is flush with the rear surface of the elevator car panel 16, i.e. the outer surface of the magnet 28 is arranged in the same plane as the rear surface of the elevator car panel 16. In the embodiment shown, the rear surface of the elevator car panel 16 is formed by the outer surface of the rear layer 20 facing the structural element 14. In consequence, the elevator car panel 16 and the magnet 28 directly abut against the front side of the structural element 14 facing the elevator car panel 16, and no gap is formed between the elevator car panel 16 and the structural element 14.

As a result, the space, which is available for passengers inside the elevator car 2, is maximized. In addition, the whole plane of the elevator car panel 16 is supported by the structural element 14. This avoids any bending of the elevator car panel 16 when it is pushed from inside the elevator car 2. The structural element 14 therefore may be formed from a material having a low rigidity. Using such a material allows to reduce the costs of the elevator car 2 even further.

Optional Features:

A number of optional features are set out in the following. These features may be realized in particular embodiments, alone or in combination with any of the other features:

In an embodiment the dimensions of the at least one opening and of the at least one magnet may be set such that the magnet does not protrude beyond the surface of the panel. In consequence, the elevator car panel directly abuts against the front side of the structural element facing the elevator car panel, and no gap is formed between the elevator car panel and the structural element.

As a result, the space, which is available for passengers inside the elevator car, is maximized. In addition, the whole plane of the elevator car panel is supported by the structural element. This avoids any bending of the elevator car panel when it is pushed from inside the elevator car. The structural element therefore may be formed from a material having a low rigidity. This allows to reduce the costs of the elevator car even further.

In an embodiment the dimensions of the at least one opening and of the at least one magnet may be set such that an outer surface of the magnet is arranged in the same plane as the rear surface of the elevator car panel. As a result, also the magnet directly abuts against the front side of the structural element causing a large magnetic force to act between the magnet and the structural element.

In an embodiment the elevator car panel may have a laminate structure comprising at least two layers, in particular a laminate structure having three layers. In an embodiment the laminate structure comprises a central foam layer which is sandwiched between two layers made of paper. Such a laminate structure allows to provide a light elevator car panel, which comprises the necessary rigidity and which may be produced at low costs.

In an embodiment the at least one opening may have a circular cross-section. Openings having a circular cross-section may be formed easily, e.g. by drilling.

In an embodiment the at least one magnet may be fixed within the opening by an adhesive. A suitable adhesive will provide a secure fixture of the magnet within the opening. This allows to securely fix the elevator car panel at the structural element(s) of the elevator car.

In an embodiment the at least one magnet may be a permanent magnet, reliably providing the necessary magnetic field without the need for an energy source. A permanent magnet may be fixed to any material having magnetic properties, in particular to any material having soft magnetic properties, e.g. steel.

The at least one magnet in particular may comprise a rare earth metal, such as neodymium, in order to provide a magnetic field having the necessary strength.

In an embodiment the elevator car panel may comprise a cup, which is arranged within the at least one opening and configured for shielding the magnetic field of the at least one magnet. This allows to enhance the magnetic force provided for fixing the elevator car panel to the adjacent structural element(s). It further reduces the magnetic field to which passengers residing within the elevator car are exposed. Exposure to a large magnetic field may be dangerous for passengers which are equipped with a cardiac pacemaker or other electronic medical devices.

In an embodiment of an elevator car the at least one structural element may be a structural panel and the elevator car panel may be oriented parallel to said structural panel. In particular, the at least one elevator car panel may be fixed to said structural panel without a gap being formed between the elevator car panel and the structural panel.

Such a configuration allows the structural elements/structural panels to support the elevator car panels over their whole width. Such a support avoids any bending of the elevator car panel when it is pushed from inside the elevator car. The structural element therefore may be formed from a material having a low rigidity. This allows to reduce the costs of the elevator car.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the dependent claims.

### REFERENCES

2 elevator car

3 bottom plate

4 interior space

14 structural element

15 rear side of the elevator car panel

16 elevator car panel

16a elevator control panel

17 front side of the elevator car panel

18 opening

19 adhesive material

20 rear layer of the elevator car panel

22 central layer of the elevator car panel

24 front layer of the elevator car panel

26 cup

28 (permanent) magnet

+plurality of push buttons

32 display

62, 63, 64 sidewalls

1. An elevator car panel (16, 16a) configured to be attached to at least one structural element (14) of an elevator car (2) and comprising:
at least one opening (18), which is formed in a surface of the elevator car panel (16, 16a) and configured for receiving at least one magnet (28); and
at least one magnet (28) arranged within said one opening (18), wherein the at least one magnet (28) is configured for magnetically fixing the elevator car panel (16, 16a) to the at least one structural element (14).

2. The elevator car panel (16, 16a) of claim 1, wherein the magnet (28) does not protrude beyond the surface of the elevator car panel (16, 16a).

3. The elevator car panel (16, 16a) of claim 2, wherein an outer surface of the magnet (28) is arranged in the same plane as a rear surface of the elevator car panel (16, 16a).

4. The elevator car panel (16, 16a) of claim 1, wherein the elevator car panel (16, 16a) has a laminate structure comprising at least two layers (20, 22, 24).

5. The elevator car panel (16, 16a) of claim 4, wherein the elevator car panel (16, 16a) has a laminate structure of three layers (20, 22, 24).

6. The elevator car panel (16, 16a) of claim 5, wherein the laminate structure comprises a central foam layer (22) which is sandwiched between two layers (20, 24) made of paper or cardboard.

7. The elevator car panel (16, 16a) of claim 1, wherein the at least one opening (18) has a circular cross-section.

8. The elevator car panel (16, 16a) of claim 1, wherein the at least one magnet (28) is fixed within the opening (18) using an adhesive (19).

9. The elevator car panel (16, 16a) of claim 1, wherein the at least one magnet (28) is a permanent magnet (28).

10. The elevator car panel (16, 16a) of claim 1, wherein the material of the at least one magnet (28) comprises a rare earth metal.

11. The elevator car panel (16, 16a) of claim 1, further comprising a cup (26), which is arranged within the at least one opening (18) and configured for directing and/or shielding the magnetic field provided by the at least one magnet (28).

12. An elevator car (2) comprising
at least one structural element (14) comprising a magnetic material; and
at least one elevator car panel (16, 16a) of claim 1.

13. The elevator car (2) of claim 12, wherein the at least one structural element (14) is a structural panel, and wherein the elevator car panel (16, 16a) is oriented extending parallel to said structural pane.

14. The elevator car (2) of claim 13, wherein the at least one elevator car panel (16, 16a) is fixed to said structural element (14) without a gap being formed between the elevator car panel (16, 16a) and the structural element (14).

15. A method of assembling an elevator car (2) comprising the steps of
providing at least one structural element (14) comprising a magnetic material;
attaching at least one elevator car panel (16, 16a) according to claim 1 to said at least one structural element (14) by means of the magnetic force provided by the at least one magnet (28).
